(19) United States
(12) Patent Application Publication
(10) Pub. No.: US 2018/0114276 A1
(43) Pub. Date: Apr. 26, 2018

(54) FINANCIAL ORGANIZATION SYSTEM

(71) Applicant: Rajiv Ramaiah, Scotttsdale, AZ (US)

(72) Inventor: Rajiv Ramaiah, Scotttsdale, AZ (US)

(21) Appl. No.: 15/608,244

(22) Filed: May 30, 2017

Related U.S. Application Data
(60) Provisional application No. 62/347,810, filed on Jun. 9, 2016.

(51) Int. Cl. G06Q 40/00

(52) U.S. Cl. CPC G06Q 40/125; G06Q 40/123

(57) ABSTRACT

A financial organization system is provided. The system accesses financial transactions of a user in one application and provides means for the user to categorize, manage and organize all financial transactions utilizing user defined tags across all accounts using a single interface. This allows for greater transparency between accounts and provides a full view of all financial activity of the user with the ease of operating a single application. The system accomplishes this without the need of storing financial transaction detailed data.

### CROSS REFERENCE TO RELATED APPLICATION

This application claims priority to U.S. Provisional Patent Application entitled “FINANCIAL ORGANIZATION SYSTEM,” Ser. No. 62/347,810, filed Jun. 9, 2016, the disclosure of which is hereby incorporated entirely herein by reference.

### BACKGROUND OF THE INVENTION

### Technical Field

This invention relates generally to a financial system and more particularly to a financial organization system.

### State of the Art

The general public is utilizing electronic systems to access bank accounts, credit card accounts, investment accounts and all types of financial transactions, investments, and the like. Often times, people will access each individual institution's system electronically in order to determine what the balance is, or to see what the expenses are and utilize the institution's system to manage the account. For people with several accounts, this becomes time consuming and difficult to properly track and further does not provide for a full picture of all financial activity. It also makes it difficult to operate a budget or the like because the means for categorizing financial transactions is limited by the systems.

Other systems have been created in order to allow users to access all financial accounts in one application and then to organize and categorize the transactions. These systems, however, are limited. These systems obtain the financial information from the financial institutions maintaining the system and store the same on its, or a third party's server. This creates a security threat by maintaining financial information on yet another server that is susceptible to cyber-attacks. Additionally, the systems do not allow for user defined categories, are not user friendly and charge a monthly fee for operation, even if the user does not need all that is available for the monthly fee.

Accordingly, there is a need for an improved financial organization system.

### SUMMARY OF THE INVENTION

The present invention relates to a financial organization system for accessing financial transactions of a user in one application and providing means for the user to categorize, manage and organize all financial transactions utilizing user defined tags across all accounts using a single interface. This allows for greater transparency between accounts and provides a full view of all financial activity of the user with the ease of operating a single application.

An embodiment of the present invention includes a financial organization system comprising: a financial server at a financial provider, the financial server containing data for a plurality of financial transactions, wherein the plurality of financial transactions correspond to a financial account of a user; a user computing device containing a mobile application for providing a user interface for accessing the system; and a computer server at a provider, the computer server containing data for the financial account, the data comprising a plurality of financial IDs corresponding to the plurality of financial transactions from the financial account and the tags corresponding to a category for the corresponding financial IDs and financial transactions, wherein each of the financial IDs do not include financial data, which computer server is coupled to the user computing device and the financial server, the computer server programmed to: receive from the user interface of the user computing device a signal indicating activation of the financial organization system; automatically identify the user activating the financial organization system in response to receiving the signal indicating activation of the financial organization system; in response to identification of the user, automatically send a signal to the financial server requesting the plurality of financial transactions of the financial account of the user; receiving a signal from the financial server including data comprising the plurality of financial transactions corresponding to the financial account of the user; automatically associating the financial IDs with the corresponding financial transactions from the financial account; and automatically generate and transmit to the user computing device a signal to display on the user computing device the plurality of financial transactions of the financial account.

Another embodiment includes a financial organization system comprising: a financial server at a financial provider, the financial server containing data for a plurality of financial transactions, wherein the plurality of financial transactions correspond to a plurality of financial accounts of a user; a user computing device providing a user interface for accessing the system; and a computer server at a provider, the computer server containing data for the financial accounts, the data comprising a plurality of financial IDs corresponding to the plurality of financial transactions from the plurality of financial accounts and the tags corresponding to a category for the corresponding financial IDs and financial transactions, wherein each of the financial IDs do not include financial data, which computer server is coupled to the user computing device and the financial server, the computer server programmed to: receive from the user interface of the user computing device a signal indicating activation of the financial organization system; automatically identify the user activating the financial organization system in response to receiving the signal indicating activation of the financial organization system; in response to identification of the user, automatically send a signal to the financial server requesting the plurality of financial transactions of the financial accounts of the user; receiving a signal from the financial server including data comprising the plurality of financial transactions corresponding to the financial accounts of the user; automatically associating the financial IDs with the corresponding financial transactions from the financial accounts; and automatically merge the financial transactions with the financial IDs in real time and transmit to the user computing device a signal to display on the user computing device the plurality of financial transactions of the financial accounts.

Yet another embodiment includes a financial organization system comprising: a financial server at a financial provider, the financial server containing data for a plurality of financial transactions, wherein the plurality of financial transactions correspond to at least one financial account of a user; a user computing device providing a user interface for accessing the system; and a computer server at a provider, the computer server containing data for the financial accounts, the data comprising a plurality of financial IDs corresponding to the plurality of financial transactions from at least one financial account and the tags corresponding to a category for the corresponding financial IDs and financial transactions, wherein each of the financial IDs do not include financial data, which computer server is coupled to the user computing device and the financial server, the computer server programmed to: operate a transaction storage algorithm to associate transaction IDs created by the financial server with financial IDs created by the computer server and store the financial IDs and transaction IDs in a memory of the computer server.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a schematic view of a financial organization system, in accordance with embodiments;

FIG. 2A is a view of a signup and login interface of a mobile computing device to access the financial organization system, in accordance with embodiments;

FIG. 2B is a view of a signup and login interface of a mobile computing device to access the financial organization system, in accordance with embodiments;

FIG. 2C is a view of a signup and login interface of a mobile computing device to access the financial organization system, in accordance with embodiments;

FIG. 2D is a view of a login interface of a mobile computing device to access the financial organization system, in accordance with embodiments;

FIG. 2E is a view of a reset password interface of a mobile computing device to access the financial organization system, in accordance with embodiments;

FIG. 2F is a view of a signup interface of a mobile computing device to access the financial organization system, in accordance with embodiments;

FIG. 2G is a view of a reset password interface of a mobile computing device to access the financial organization system, in accordance with embodiments

FIG. 3 is a view of a home user interface and a tag user interface of the financial organization system for viewing financial transactions on the home user interface and creating user defined tags for organizing the user's financial transactions using the tag user interface, in accordance with embodiments;

FIG. 4 is a view of an accounts user interface of the financial organization system, in accordance with embodiments;

FIG. 5 is a view of a profile user interface of the financial organization system, in accordance with embodiments;

FIG. 6 is a view of sending interface for sending data from the system for use in external programs and the like, in accordance with embodiments;

FIG. 7 is a view of exported data via email having a tax tag assigned to the transactions from the financial organization system and sorted according to tag, in accordance with embodiments;

FIG. 8A is a view of an account user interface of the financial organization system for adding notes and images to a transaction, in accordance with embodiments;

FIG. 8B is a view of an account user interface of the financial organization system for adding notes and images to a transaction, in accordance with embodiments;

FIG. 8C is a view of an account user interface of the financial organization system for adding notes and images to a transaction, in accordance with embodiments;

FIG. 9A is a view of an add account user interface of the financial organization system, in accordance with embodiments;

FIG. 9B is a view of an add account user interface of the financial organization system, in accordance with embodiments;

FIG. 9C is a view of an add account user interface of the financial organization system, in accordance with embodiments;

FIG. 9D is a view of an add account user interface of the financial organization system, in accordance with embodiments;

FIG. 9E is a view of an add account user interface of the financial organization system, in accordance with embodiments;

FIG. 9F is a view of an add account user interface of the financial organization system, in accordance with embodiments;

FIG. 9G is a view of a financial institution login screen of the financial organization system, in accordance with embodiments;

FIG. 9H is a view of a financial institution login screen of the financial organization system, in accordance with embodiments

FIG. 9I is a view of a financial institution login screen of the financial organization system, in accordance with embodiments

FIG. 9J is a view of a financial institution login screen of the financial organization system, in accordance with embodiments

FIG. 9K is a view of a financial institution login screen of the financial organization system, in accordance with embodiments.

### DETAILED DESCRIPTION OF EMBODIMENTS OF THE INVENTION

As discussed above, embodiments of the present invention relate to a financial organization system for accessing financial transactions of a user in one application and providing means for the user to categorize, manage and organize all financial transactions utilizing user defined tags across all accounts using a single interface. This allows for greater transparency between accounts and provides a full view of all financial activity of the user with the ease of operating a single application.

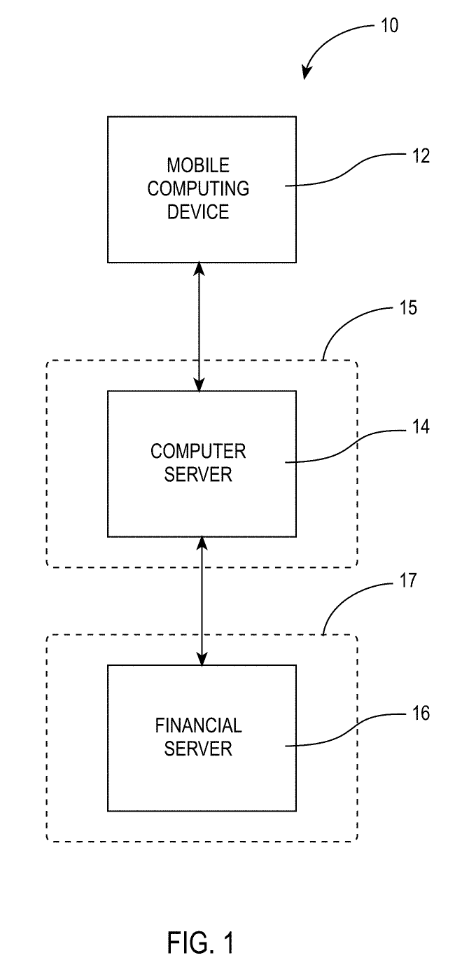

Referring to FIG. 1, an embodiment of a financial organization system 10 is depicted. The system 10 includes a user computing device 12, such as mobile computing device 12 that is coupled to and in communication with a computer server 14 located in a secured environment 15, wherein the secured environment 15 requires a user name and password in order to access the computer server 14. The computer server 14 is coupled to or in communication with a financial server 16 that is located within an institution secured environment 17, wherein the secured environment 17 requires a user name and password in order to access the financial server 16. The mobile computing device 12 may be coupled to the computer server 14 through a network connection, such as a wireless network connection. The computer server 14 may be coupled to the financial server 16 with a network connection. Further, the network connection may be through a secure sockets layer connection. The user computing device 12 may be a mobile computing device or another type of computing device that is operable with the system 10. In instances where the user computing device 12 is a conventional computer, such as a desktop or laptop, wherein a web interface allows access to the system 10 as opposed to a mobile computing device operating a mobile application.

The mobile computing device 12 contains a mobile application stored in a memory of the mobile computing device 12, wherein the mobile application provides instructions executable by a processor of the mobile computing device 12 in order to initiate actions of the financial organization system 10. The mobile application is a lightweight application requiring little memory space and requiring minimal processing resources to operate, thereby increasing the speed of operation by not requiring heavy computer resources to operate the mobile application.

The computer server 14 contains a software application stored in a memory of the computer server 14, wherein the software application provides instructions executable by a processor of the computer server 14 in order to communicate with the financial server 16 to obtain financial transaction information and send the same information to the mobile computing device 12 for display, thereby allowing the user to tag each financial transaction to categorize, add notes and images of receipts or as many images the user may choose to the same. In embodiments, the financial server 16 assigns random transaction IDs to each financial transaction and these random transaction IDs are utilized to associate the system financial IDs and tags from the computer server 14 with the random transaction IDs.

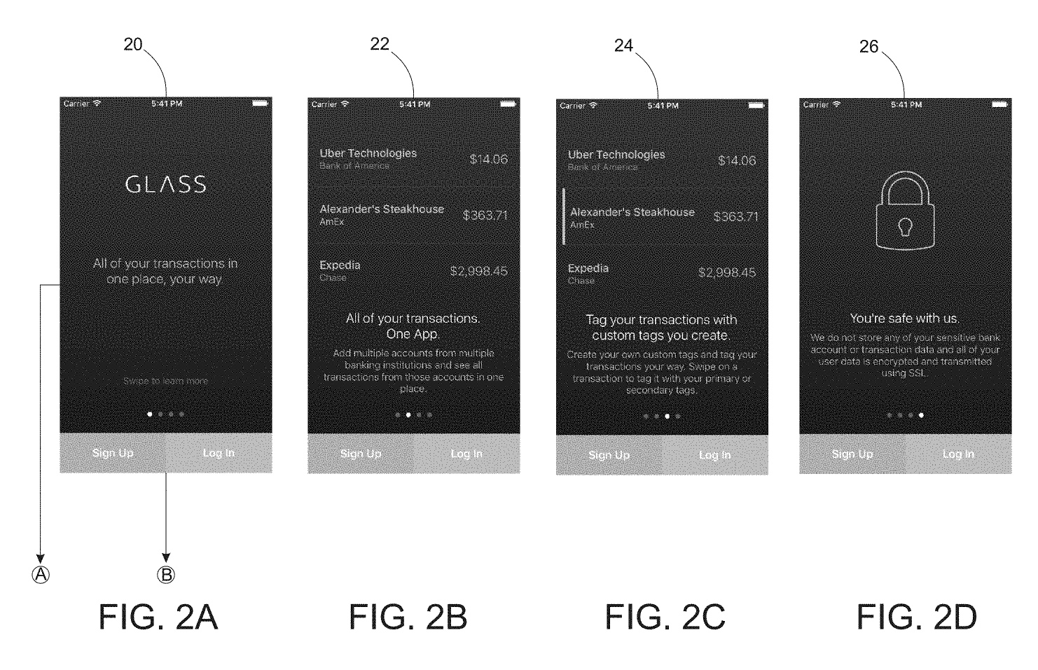

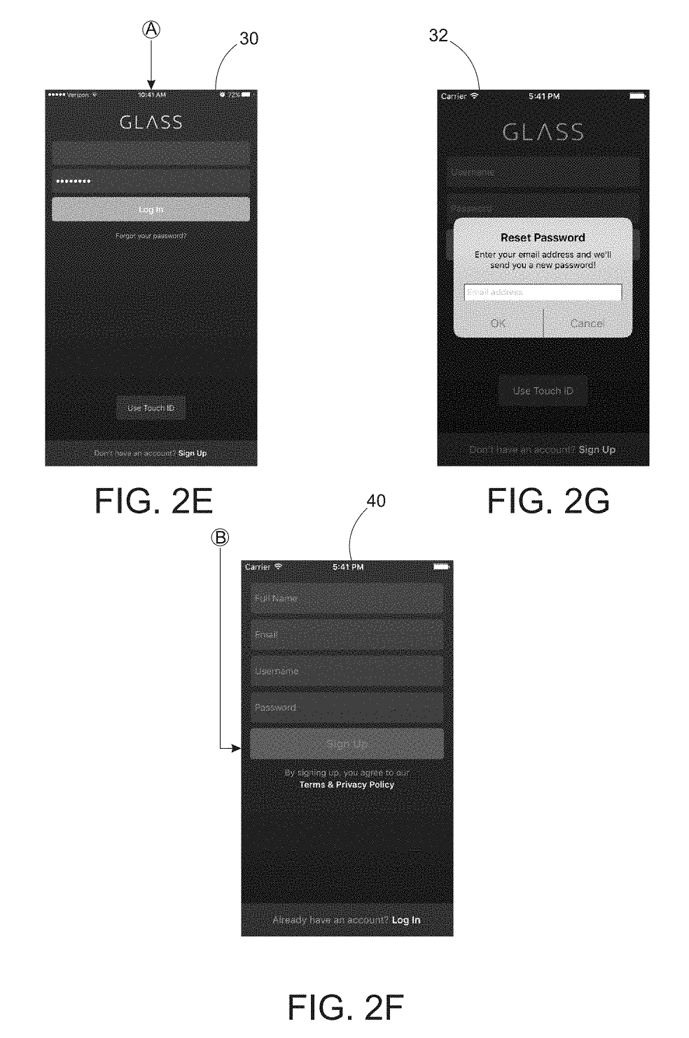

Referring further to the drawings, FIGS. 2A-2G depict a signup/login interface 20 of the mobile computing device to access the financial organization system 10 according to an embodiment. The signup/login interface 20 may have various implementations as depicted in interface configurations 22, 24 and 26. Selecting the signup button on the signup/login interface 20 automatically displays a signup interface 40. The signup interface operates to collect user information, including, but not limited to name and contact information of the user, a login user name, password, and the like. Once the information is input in the signup interface 40, the user may select a “Sign Up” button in order to create a user account with the financial organization system 10. The signup process may include entering a payment instrument in order to pay for use of the financial organization system 10.

The user that is signed up may then select the login button wherein the signup/login interface 20 automatically displays a login interface 30. The login interface 30 allows the user to enter his or her user name and password to access the financial organization system 10. If the user forgets the password, the user may select a link, wherein a reset password interface 32 is displayed to guide the user through a password resetting process.

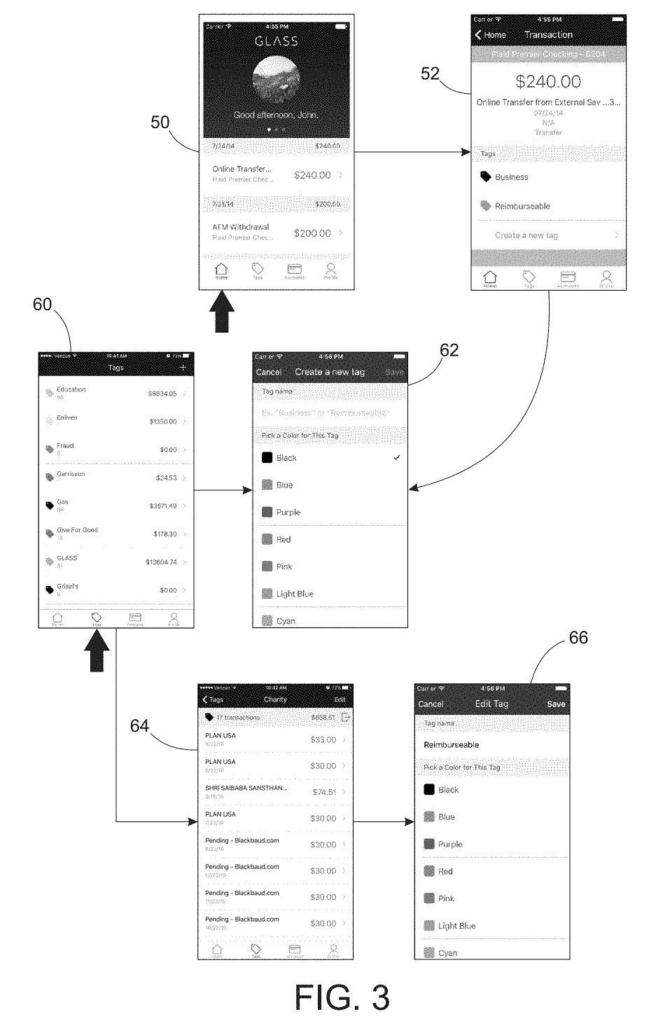

Referring again to the drawings, FIG. 3 depicts the user interface once a user logs in to the system 10. There are at least four user interfaces that may be utilized with the system 10. FIG. 3 depicts a home interface 50 that depicts a plurality of financial transactions from a plurality of financial accounts of the user. The user may then operate the system 10 to categorize the financial transactions by assigning a tag to each financial transaction. The tags may be applied in one of two ways. A first way to apply a tag is to slide the financial transaction left or right, where the motion of sliding the financial transaction left is associated with a first commonly used tag and sliding the financial transaction right is associated with a second commonly used tag. In embodiments, the user may assign the same commonly used tag to the left and right slide.

A second way of assigning tags to transactions includes selecting the transaction from the home interface 50. The mobile computing device automatically displays a transaction interface 52 that includes the option of applying or associating a tag with the selected financial transaction. In instances where the existing tags do not reflect how the user wishes to categorize the selected financial transaction, the user may select an option to create a tag. The mobile computing device 12 may then depict a tag-creation interface 62, wherein the user may create a tag to associate with the selected transaction. The created tag is then saved for use later on other financial transactions.

Another way to manage and create tags is through selection of the tags interface 60. Selecting a button directed to adding new tags automatically displays the tag-creation interface 62 to create a tag as previously described. Selecting a particular tag results in the mobile device automatically displaying a tag interface 64, wherein the tag interface 64 depicts a summary of the financial information associated with the tag, such as the total number and amount of transactions corresponding to the selected tag, each transaction and the transaction amount corresponding to the selected tag, and the like. The user may select an edit button to edit the tag, such as, but not limited, editing the text and the color of the tag, as depicted in edit tag interface 66.

It will be understood that multiple tags may be applicable to a financial transaction and the system 10 operates to allow multiple tags to be applied to a single financial transaction.

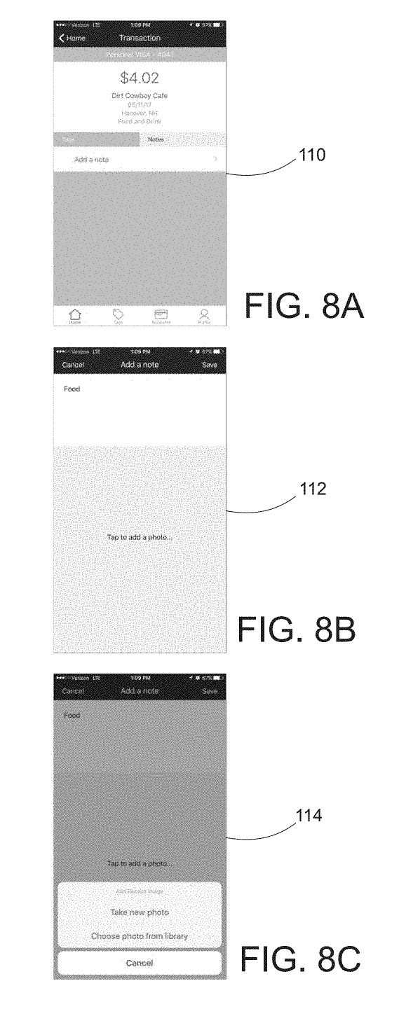

Referring additionally to the drawing figures, FIGS. 8A-8C show an embodiment of adding notes in addition to adding tags. The add notes button may be selected as shown on interface screen 110. The user may then add notes as shown in interface screen 112, wherein the notes are now associated with the financial transaction. The user may then utilize a camera or scanning device of the user computing device to image a receipt, invoice or the like associated with the financial transaction as shown in interface screen 114. This allows for all information needed for things like reimbursements, taxes and the like to be stored and accessible through the system 10.

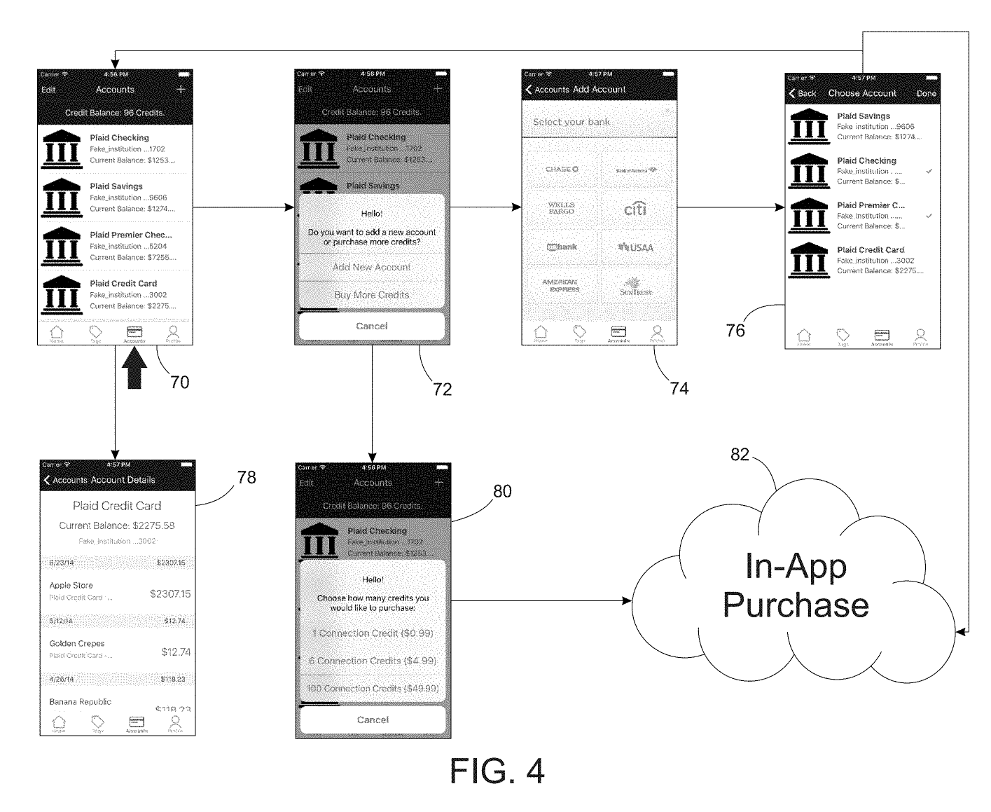

As depicted in FIG. 4, the user may select an accounts interface 70 according to embodiments. The accounts interface 70 allows a user to manage financial accounts by deleting an account, adding an account, or reviewing financial transactions of an account. Deleting an account includes selecting the option to delete an account. Adding an account includes selecting the add account button to display a user prompt to add an account or add additional credits. The system operates on credits wherein each financial account added to a user's system account costs a predetermined amount of credits each month. This allows the user to control how much he or she pays for use of the system 10. Rather than a flat rate fee for use of all features of the system, the user pays utilizing credits, wherein the credits apply per number of accounts. This lets the user have full control of how much he or she uses the system to organize financial accounts. It will be appreciated that in some embodiments, payment for access and use of the system 10 may be a monthly payment or some other type of regular payment schedule.

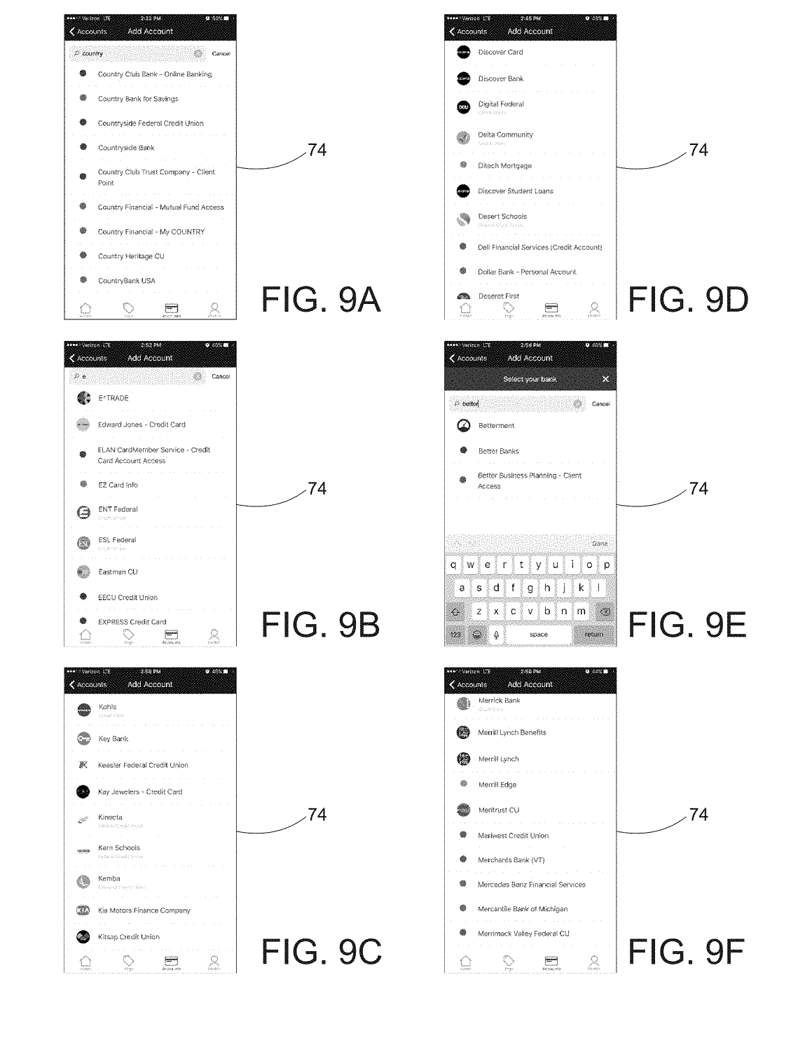

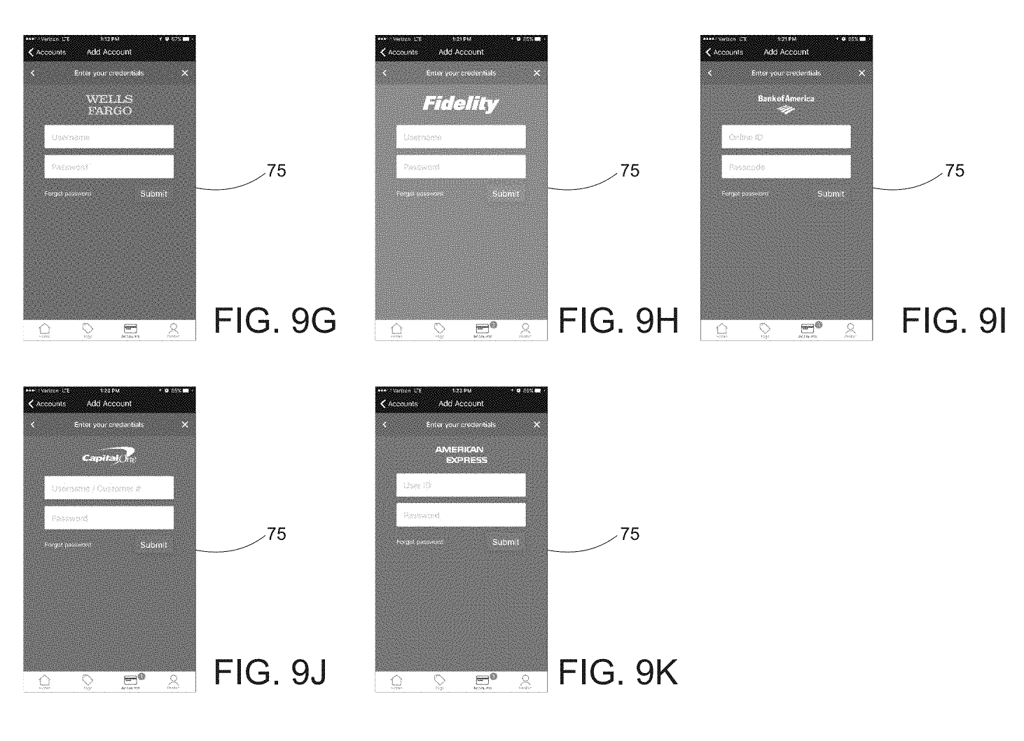

If there are not enough credits to add an account, the user selects add credits and the mobile computing device 12 may then display a purchase credit prompt 80. The user selects the amount of credits to purchase and an in app purchase 82 is affected. Now the user may add an account by selecting the add account button from the account interface 70 and selecting add account in the add account prompt 72. The mobile computing device then displays an add account interface 74. The add account interface 74 includes shortcut selections of banks or financial institutions that the user can select (various embodiments of the add account interface 74 is provided for in FIGS. 9A-9F). In some embodiment, the add account interface 74 allows a user to enter manually the financial institution the user wishes to add. Once a financial institution has been selected and secure login authenticated by use of financial institution login interface 75, including, but not limited to the various financial institution login interface 75 embodiments shown in FIGS. 9G-9K, the user may then use account type interface 76 to add the account type he or she has with that financial institution that he or she wishes to access using the system 10. It will be understood that the financial institution login interface 75 is the login interface provided by the financial institution and not one provided by the system 10, wherein the system 10 is programmed to access the financial institution login interface 75. This enables users to access accounts without the need of supplying identifying information such as name, address, phone number, social security number, and the like, thereby increasing security.

From the accounts interface 70, the user may select a particular listed account. The mobile computing device 12 may then display the financial transactions associated with the selected account as shown in account details interface 78.

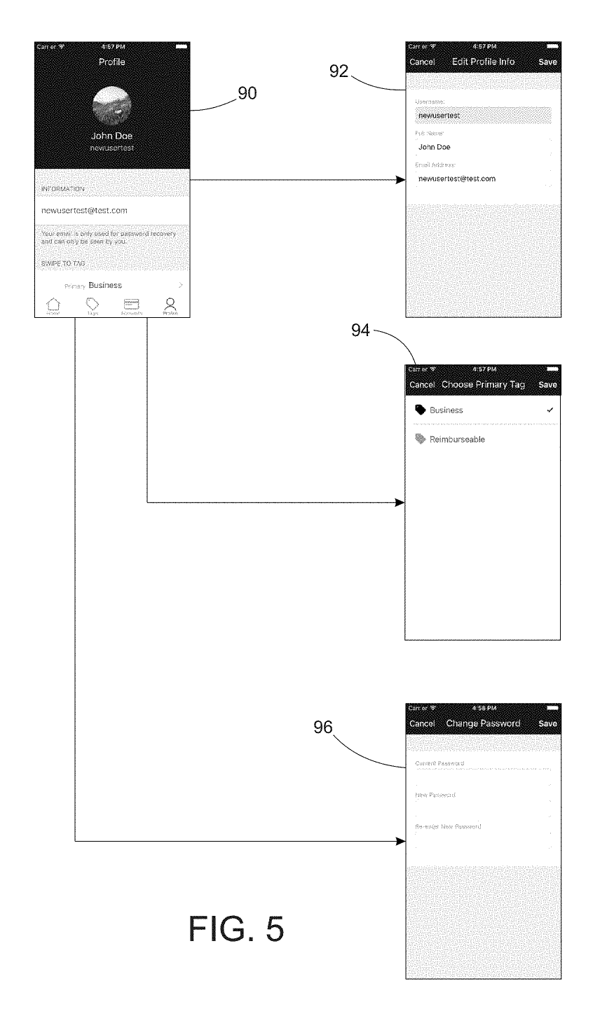

Referring to the drawings, FIG. 5 depicts a profile user interface 90 of the financial organization system 10, according to embodiments. The profile user interface 90 allows access to an edit profile info interface 92 to update/change the information associated with the user's profile. Further, the profile user interface 90 allows access to a choose primary tag interface 94 to update/change the primary tags used by the user during operation of the financial organization system 10; and the profile user interface 90 allows access to a change password interface 96, wherein the user may change the password required to access the financial organization system 10.

In operation, the computer server 14 is programmed to perform certain tasks automatically. As part of this programming, particular algorithms provide the necessary functionality, such as, but not limited to a credit collection algorithm and a transaction storage algorithm.

### Credit Collection Algorithm

The purpose of the credit collection algorithm is the app user is charged a predetermined number of credits, such as, but not limited to 1 credit per month, per financial account to download transactions to the system 10. This charge needs to occur whether or not the user has recently accessed the system 10. It is therefore implemented with a server-based “credit collection” process/algorithm, which includes:
1. When the user first connects to one of his or her financial accounts, the server records the date and time (“timestamp”). This timestamp is initially the moment of “last renewal” meaning the last time the user accessed the system 10.
2. Every hour, the server retrieves a list of active (i.e. connected) accounts whose “last renewal” was over 30 days ago.
3. The server then looks to see if any of the users with an account that needs renewing already have a negative credit balance.
   a. For users with a negative credit balance, any accounts that need renewing are in fact marked as disconnected/inactive and all associated transactions deleted.
   b. If an account that is disconnected is the ONLY account from a particular institution, the financial server API is invoked to delete that token from the financial server system. This step prevents further charges accruing for the user/institution combination.
4. The remaining accounts that need renewing now belong to users with a zero or positive credit balance.
5. The server processes each account renewal by extending the “last renewed” date by 30 days and deducting 1 credit from the user's balance. This may result in their balance becoming negative, or becoming more negative.
6. On completion the process terminates, ready for invocation 1 hour later.

### Transaction Storage Algorithm

The purpose of the transaction storage algorithm is that the app does NOT store detailed information on each of the user's transactions. It does, however, store a transaction ID for each transaction in order to match with tags. This information is merged with the financial transactions each time the system 10 operates. Additionally, the financial server 16 data has a “window” of availability (for example 1 year, however the “window” may be any amount of time determined by the system or the account). In this example, on Jan. 1, 2016, all data in 2015 would have been available from financial server 16. On Jan. 2, 2016, only data from Jan. 2, 2015 would be available. The data from Jan. 1, 2015 has been dropped from the financial server 16 dataset. Thus, when a dataset is received from financial server 16, it must be matched to the set of transaction IDs found on the server:
1. Any transaction IDs found in both the financial server 16 data and the computer server data can be ignored.
2. Any transaction IDs found in the financial server 16 data and NOT in the computer server data must be added to the computer server data (they are new).
3. Any transaction IDs found in the computer server data and NOT in the financial server 16 data MIGHT have “expired”—either because the transaction is older than the institution's data window, or because the transaction was deleted for some reason. If the transaction has expired (i.e. no longer be available from financial server 16), it must be deleted along with its associated tags, etc.

It is also possible that a transaction stored in the computer server database is missing from the financial server 16 dataset due to some kind of transient error (network interruption, system glitch, etc.). Although it would get added back to the computer server database later, when it reappeared in the financial server 16 dataset, deleting the data from the computer server database immediately (along with its associated tags etc.) would cause confusion to the user, since the tags would need to be re-added. The algorithm used to handle this scenario is as follows:
1. Each transaction has a “missing count” which starts at zero when the transaction is newly added.
2. Any transaction with a “missing count” greater than 0 is regarded as “deleted” by the system, even though the data remains in the computer server database.
3. When a new dataset arrives from financial server 16, all the transactions associated with the account(s) supplied by financial server 16 are updated with their “missing count” increased by 1.
4. Each financial server 16 transaction is processed in turn:
   a. If the transaction is found in the computer server database, its “missing count” is set to zero.
   b. If the transaction is NOT found in the computer server database, it is added (with a “missing count” of zero).
5. At the end of this process, if any transactions in the computer server database have a “missing count” of 5, they are deleted along with their associated tags.

This algorithm therefore always reflects the content of the most recent financial server 16 dataset, but is “fault tolerant” with regard to data that is dropped, by requiring the “missing count” to count to 5 before a transaction is deleted from the computer server data. Assuming users typically refresh their app dataset once or twice per day, there will be a 1-2 day “grace period” during which missing data can reappear without losing its user-defined tags and other associated data.

With these algorithms, the system operation can occur. According to embodiments, the financial organization system 10 includes a financial server 16 at a financial provider. The financial server 16 contains data for a plurality of financial transactions, wherein the plurality of financial transactions correspond to a plurality of financial accounts of a user. The system 10 includes a mobile computing device 12 containing a mobile application for providing a user interface for accessing the system 10. The system 10 includes a computer server 14 at a provider, wherein the computer server 14 contains data for each of a plurality of financial accounts, the data comprising a plurality of financial IDs and associated tags. Financial IDs correspond to the plurality of financial transactions from the plurality of financial accounts and the tags correspond to a category and/or attached notes and/or pictures for the corresponding financial IDs and financial transactions. Each of the financial IDs do not include financial data. The computer server 14 is coupled to the mobile computing device 12 and the financial server 16. The computer server 14 is programmed to: i. receive from the user interface of the mobile computing device 12 a signal indicating activation of the financial organization system 10; automatically identify the user activating the financial organization system 10 in response to receiving the signal indicating activation of the financial organization system 10; in response to identification of the user, automatically send a signal to the financial server 16 requesting the plurality of financial transactions of the plurality of accounts of the user; receiving a signal from the financial server 16 including data comprising the plurality of financial transactions corresponding to the plurality of financial accounts of the user; automatically associating the financial IDs and tags with the corresponding financial transactions from the plurality of financial accounts; and automatically generate and transmit to the mobile computing device 12 a signal to display on the mobile computing device the plurality of financial transactions of the plurality of accounts with the corresponding tags, with any attached notes and/or pictures.

When financial transactions are new to the system 10, a new financial ID is associated with each new financial transaction and the financial IDs created are stored in a database of the computer server 14. The new financial transactions in the system 10 may then be assigned a tag by the user. The tag associated with the financial ID of that transaction is stored in the database of the computer server 14. This allows for later association of the financial ID and tag with the financial transaction.

It should be understood that the system 10 does not store the details of financial transactions in the database of the computer sever 14. Rather, each time the application is accessed, a signal or request for data is sent to the financial server 16 to obtain all of the financial transactions from the plurality of financial accounts of the user. The system 10 operates to associate the corresponding transaction IDs and corresponding tags to the financial transaction each time the system is accessed, or in other words the transaction IDs and corresponding tags to the financial transactions are merged in real time. This improves security of the financial data by not retrieving and storing the financial transaction data on a separate server.

While the system 10 is directed to financial organization, other embodiments may utilize the components of the system in other industries, such as insurance, medical records, claims and the like industries where there may be a transfer of confidential to sensitive information. These embodiments of the system 10 may then apply ID tags to the information in a similar manner as described with regard to the transaction ID. This allows for secure retrieval and organization of confidential or sensitive information without the need to store the confidential or sensitive information on a server for access by the system.

The algorithm also addresses secure retrieval of sensitive information from a foreseeable Health Information API. For example, and without limitation, it is contemplated that the algorithm is a solution to scattered medical information being inputted to a “Health Information” API. Each patient's information being allocated a unique ID with or without requirement of a PIN for retrieval. The algorithm allocating unique IDs to important information requiring privacy and security would therefore apply to many databases which have the threat of security breaches to a veritable secure database that can be interacted with using these unique IDs to access data securely only when needed.

Embodiments of the financial organization system 10 may also include credit monitoring capabilities. For example, and without limitation, the system 10 may allow a user to establish customized alerts for accounts accessed by the system 10. For example, the user may set an alert for an account at risk, an alert for dormant credit cards that could be accessed due to identity theft, an alert for suspicious activity on a card, such as variations in geographic location of use in a short time period, and any other alert. With all accounts providing financial data to a single system 10, it allows a user to easily reconcile the various accounts and obtain necessary information, such as location of use and the like that allows a user to quickly and efficiently address the issues created by identity theft matters.

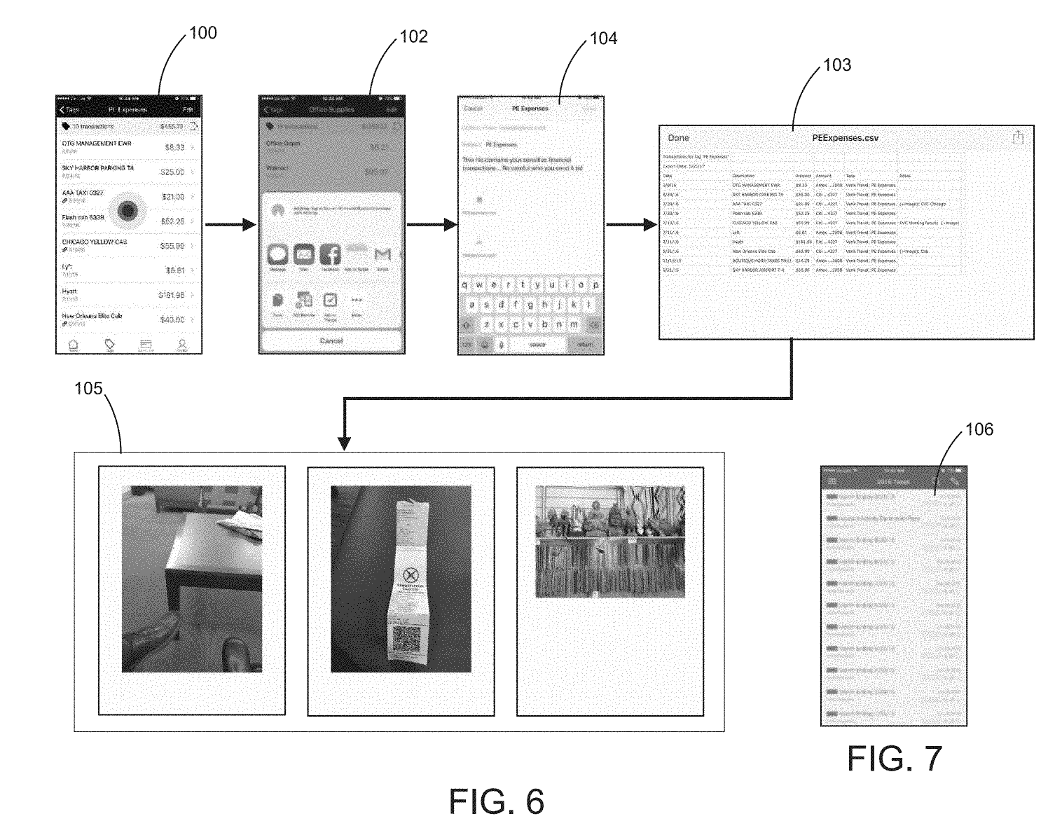

In some embodiments, the system 10 may provide means for exporting the financial data organized using the system 10, as shown in FIG. 6. For example, and without limitation, the system 10 may provide for a live database creation as shown in live database interface 100 that depicts a summary of the financial information associated with an individual tag assigned to various transactions, such as the total number and amount of transactions corresponding to the selected individual tag, each transaction and the transaction amount corresponding to the selected individual tag, notes and/or images attached, and the like. The user may select an export option, wherein the export interface 102 is depicted and the user can select the manner in which to export the information. For example, the user may select to email, wherein an email interface 104 is displayed on the computing device and the system 10 automatically attaches the financial data being exported as a csv format file 103 for a user to utilize the financial information with other software and for archival purposes, and all images attached to that database are simultaneously exported as a PDF in the same email or other form of exporting. To form these images, the system 10 may include the use of an imaging device, such as, but not limited to a camera of a mobile device, to image an invoice or receipt and store it in the computer server and associate it with the transaction ID. These images may be compressed to a useable size based on the size and data limitations of the various device systems. Further, exporting the financial data may further include exporting a document 105 containing the imaged receipt, image of product, image of other information or invoice in a useable format, such as PDF, JPG, PNG, or other image file type. The ability for the system 10 to export the financial data may remove the need for additional accounting software. Additionally, as while some embodiments include the user initiating an export of the data, the system 10 may include an ability to automatically export the financial data, such as on a recurring predetermined date.

Additionally, a user may create databases at user defined frequency, such as month-end databases. In these embodiments, the 12 month-end databases can be merged into one excel database and sorted as needed with all tags, notes and image details for accounting purposes for a particular year. As described earlier, the system 10 operates to not store financial information and therefore, these databases are live, meaning that they are created each time the system 10 is accessed and operated, and not stored by the system 10. Accordingly, the databases are only created and accessed by user and therefore, exporting the financial data allows the user to store the exported data for future use. Once the system 10 is closed or ended, the database is deleted or otherwise gone.

Referring additionally to FIG. 7, an email interface 106 may be utilized to sort by tags, for example, financial information that is relevant for tax purposes which may be organized and exported as described with regard to FIG. 6 via email. This allows for an easy collection of financial data for tax purposes and creates greater ease for organizing financial data for preparation of the user's tax returns simply by using the email interface 106. While it is shown that the tax tags or other tags may be sorted using the email interface 106, other embodiments include sorting capabilities in any format and application that the data may be exported into.

With regard to tax information, it should be understood that some embodiments of the system 10 includes auto recognition of the tax form information. The system 10 includes the computer server programmed to interface with tax preparation software to communicate tax related information to the tax preparation software or otherwise import into the tax software.

Aspects of the present invention may take the form of an entirely hardware embodiment, an entirely software embodiment (including firmware, resident software, micro-code, etc.) or an embodiment combining software and hardware aspects that may all generally be referred to herein as a “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A financial organization system comprising:
a. a financial server at a financial provider, the financial server containing data for a plurality of financial transactions, wherein the plurality of financial transactions corresponding to a financial account of a user;
b. a user computing device containing a mobile application for providing a user interface for accessing the system; and
c. a computer server at a provider, the computer server containing data for the financial account, the data comprising a plurality of financial IDs corresponding to the plurality of financial transactions from the financial account and the tags corresponding to a category for the corresponding financial IDs and financial transactions, wherein each of the financial IDs do not include financial data, which computer server is coupled to the user computing device and the financial server, the computer server programmed to:
i. receive from the user interface of the user computing device a signal indicating activation of the financial organization system;
ii. automatically identify the user activating the financial organization system in response to receiving the signal indicating activation of the financial organization system;
iii. in response to identification of the user, automatically send a signal to the financial server requesting the plurality of financial transactions of the financial account of the user;
iv. receiving a signal from the financial server including data comprising the plurality of financial transactions corresponding to the financial account of the user;
v. automatically associating the financial IDs with the corresponding financial transactions from the financial account; and
vi. automatically generate and transmit to the user computing device a signal to display on the user computing device the plurality of financial transactions of the financial account.

2. The system of claim 1, wherein the computer server is further programmed to automatically generate a new financial ID corresponding with each new financial transaction provided by the financial server.

3. The system of claim 2, wherein the computer server is further programmed to automatically store each new financial ID created in a database of the computer server.

4. The system of claim 3, wherein the computer server is further programmed to assign a tag to each new financial ID in response to receiving a signal from the mobile computing device associating a tag with each new financial ID.

5. The system of claim 4, wherein the computer server is further programmed to automatically store each tag assigned to each new financial ID in a database of the computer server.

6. The system of claim 1, wherein the computer server is further programmed to export financial data including the plurality of financial transactions of the plurality of accounts with the corresponding tags in response to receiving a signal to export from the mobile computing device.

7. The system of claim 1, wherein the computer server is further programmed to not store details of the plurality of the financial transactions of the plurality of financial accounts.

8. The system of claim 1, wherein the plurality of financial transactions correspond to a plurality of financial accounts of the user, wherein the computer server is further programmed to
i. in response to identification of the user, automatically send a signal to the financial server requesting the plurality of financial transactions of the plurality of accounts of the user;
ii. receiving a signal from the financial server including data comprising the plurality of financial transactions corresponding to the plurality of financial accounts of the user;
iii. automatically associating the financial IDs and tags with the corresponding financial transactions from the plurality of financial accounts; and
iv. automatically generate and transmit to the mobile computing device a signal to display on the mobile computing device the plurality of financial transactions of the plurality of accounts with the corresponding tags.

9. The system of claim 1, wherein the user computing device is a mobile computing device containing a mobile application for providing a user interface for accessing the system.

10. A financial organization system comprising:
a. a financial server at a financial provider, the financial server containing data for a plurality of financial transactions, wherein the plurality of financial transactions correspond to a plurality of financial accounts of a user;
b. a user computing device providing a user interface for accessing the system; and
c. a computer server at a provider, the computer server containing data for the financial account, the data comprising a plurality of financial IDs corresponding to the plurality of financial transactions from the plurality of financial accounts and the tags corresponding to a category for the corresponding financial IDs and financial transactions, wherein each of the financial IDs do not include financial data, which computer server is coupled to the user computing device and the financial server, the computer server programmed to:
i. receive from the user interface of the user computing device a signal indicating activation of the financial organization system;
ii. automatically identify the user activating the financial organization system in response to receiving the signal indicating activation of the financial organization system;
iii. in response to identification of the user, automatically send a signal to the financial server requesting the plurality of financial transactions of the plurality of financial accounts of the user;
iv. receiving a signal from the financial server including data comprising the plurality of financial transactions corresponding to the financial accounts of the user;
v. automatically associating the financial IDs with the corresponding financial transactions from the financial accounts; and
vi. automatically merge the financial transactions with the financial IDs in real time and transmit to the user computing device a signal to display on the user computing device the plurality of financial transactions of the financial account.

11. The system of claim 10, wherein the computer server is further programmed to assign a tag to each financial ID in response to receiving a signal from the user computing device associating the tag with each financial ID.

12. The system of claim 11, wherein the computer server is further programmed to automatically store each tag assigned to each financial ID in a database of the computer server.

13. The system of claim 10, wherein the computer server is further programmed to export financial data including the plurality of financial transactions of the financial accounts with the corresponding tags in response to receiving a signal to export from the user computing device.

14. The system of claim 10, wherein the computer server is further programmed to not store details of the plurality of the financial transactions of the financial accounts.

15. A financial organization system comprising:
a. a financial server at a financial provider, the financial server containing data for a plurality of financial transactions, wherein the plurality of financial transactions correspond to at least one financial account of a user;
b. a user computing device providing a user interface for accessing the system; and
c. a computer server at a provider, the computer server containing data for the financial account, the data comprising a plurality of financial IDs corresponding to the plurality of financial transactions from the at least one financial account and the tags corresponding to a category for the corresponding financial IDs and financial transactions, wherein each of the financial IDs do not include financial data, which computer server is coupled to the user computing device and the financial server, the computer server programmed to:
i. operate a transaction storage algorithm to associate transaction IDs created by the financial server with financial IDs created by the computer server and store the financial IDs and transaction IDs in a memory of the computer server.

16. The system of claim 15, wherein the computer server programmed to operate the transaction storage algorithm comprises:
a. receive from the user interface of the user computing device a signal indicating activation of the financial organization system;
b. automatically identify the user activating the financial organization system in response to receiving the signal indicating activation of the financial organization system;
c. in response to identification of the user, automatically send a signal to the financial server requesting the plurality of financial transactions of the at least one financial account of the user;
d. receiving a signal from the financial server including data comprising the plurality of financial transactions corresponding to the financial account of the user;
e. automatically associating the financial IDs with the corresponding financial transactions from the financial account; and
f. automatically merge the financial transactions with the financial IDs in real time and transmit to the user computing device a signal to display on the user computing device the plurality of financial transactions of the financial account.

17. The system of claim 16, wherein the computer server programmed to operate the transaction storage algorithm comprises deleting transaction IDs and associated financial IDs in response to the financial transaction no longer being available when the financial server provides the financial transactions.

18. The system of claim 15, wherein the computer server is further programmed to operate a credit collection algorithm to charge the user a predetermined number of credits for access to the system.

19. The system of claim 18, wherein credits are purchased for a predetermined amount of money by the user.

20. The system of claim 15, wherein the computer server is programmed to not store financial information.
